(19) United States
(12) Patent Application Publication
(10) Pub. No.: US 2011/0208843 A1
(43) Pub. Date: Aug. 25, 2011

(54) Method and Arrangement for Improved Configuration of a Network Device

(75) Inventors: Magnus Johansson, Linkoping (SE); Peter Nilsson, Linkoping (SE)

(73) Assignee: TELEFONAKTIEBOLAGET LM ERICSSON (PUBL), Stockholm (SE)

(21) Appl. No.: 13/127,579

(22) PCT Filed: Nov. 5, 2008
(86) PCT No.: PCT/SE08/51262

§ 371 Date: May 4, 2011

(51) Int. Cl. G06F 15/177

(52) U.S. Cl. 709/220

(57) ABSTRACT

In a method in an intermediate gateway device enabling improved configuration of a device in an IP system, said device being associated with a first network for utilization of a resource associated with a second network, where said two networks are in communication via said intermediate gateway device, performing the steps of receiving (S10) a request for a set of configuration parameters associated with said resource from said device, relaying (S20) said configuration request to said resource; and retrieving and forwarding (S30) said requested configuring parameters from said resource to said device to enable improved configuration of said device.

### TECHNICAL FIELD

The present invention relates to Internet Protocol Television (IPTV) networks in general, specifically to methods and arrangements for improved management of client devices in such networks.

### BACKGROUND

The so-called IPTV (Internet Protocol Television) is a system where a digital television service is delivered using Internet Protocol over a network infrastructure, which may include delivery by a broadband connection. A general definition of IPTV is television content that instead of being delivered through traditional broadcast and cable formats, is received by the viewer through the technologies used for computer networks. The subscriber is able to received TV programs and services on his TV set connected to an IP network via a terminal called STB (Set Top Box). For residential users IPTV is often provided in conjunction with Video-on-Demand and may be bundled with Internet services such as Web access and VoIP.

The previously mentioned Set-top-boxes (STB) are adapted to use different configuration parameters to configure the box at boot-time. These configuration parameters are retrieved by using the so-called DHCP protocol. The set of configuration parameters needed by the STB is not standardized and each STB vendor and model may require different sets of parameters.

Upon boot or configuration of the set-top-box, a user or subscriber is forced to manually retrieve suitable configuration parameters for the specific device. For many users this can be a complicated task, and might result in configuration errors and consequently a flawed user experience.

### SUMMARY

Due to the above-mentioned problems, there is a need for methods and arrangements to improve the configuration process to enable more user friendly procedures.

A general aim of the present invention is to provide improved IPTV service, specifically, to provide a simplified and user neutral configuration process.

Basically, the present invention concerns a method in an intermediate gateway device to enable improved configuration of a device in an IP system. The device is typically associated with a first network for utilization of a resource associated with a second network, where the two networks are in communication or connected via the intermediate gateway device. Accordingly, a request for a set of configuration parameters associated with said resource is received (S10) from the device. The configuration request is relayed (S20) to the resource. And, the requested configuration parameters are retrieved and forwarded (S30) from said resource, via the gateway device and to the device to enable improved configuration of the device.

Advantages of the present invention include:
A simplified configuration process
Improved user friendliness
Quicker configuration.

### BRIEF DESCRIPTION OF THE DRAWINGS

The invention, together with further objects and advantages thereof, may best be understood by referring to the following description taken together with the accompanying drawings, in which:

FIG. 1 is an illustration of a general embodiment of a system in which the present invention can be implemented;

FIG. 2 is an illustration of an embodiment of the present invention;

FIG. 3 is a flow diagram of an embodiment a method according to the present invention;

FIG. 4 is an illustration of an embodiment of an arrangement according to the present invention;

FIG. 5 is an illustration of a further embodiment of an arrangement according to the present invention;

FIG. 6 is a flow diagram of an embodiment of a method according to the present invention, applicable in the arrangement of FIG. 5.

### ABBREVIATIONS

### DHCP Dynamic Host Configuration Protocol

### IPTV IP Television

### NAT Network Address Translation

### RGW Residential GateWay

### STB Set-Top Box

### DETAILED DESCRIPTION

The present invention will be described in the context of an IPTV network, specifically such a network utilizing the DHCP protocol and with a network address translation (NAT) functionality. However, the invention can be easily generalized to a more general network.

For devices such as STBs connected to an IPTV network via a bridging or routing so called Residential Gateway (RGW) the configuration e.g. DHCP requests from the STB can be forwarded to and answered typically by a DHCP Server in the IPTV network with standard methods, normal DHCP or DHCP Relaying.

When the STB is connected to a gateway unit or device that is configured to use NAT, which is very common for such gateway devices, the DHCP server is normally located in the RGW. The problem of known systems is to get the DHCP options to the STB for different STB vendors and models when the STB is not served by the DHCP server in the IPTV network. DHCP relaying is not suitable since the RGW is normally using private IP addresses on the LAN side. The DHCP server in the RGW is therefore statically configured with the needed DHCP options, which provide the STB with its configuration.

Since the RGW is located at the end users premises, the configuration of the RGW has to be performed by the end user. However, this may be a complicated task for the unskilled user, which may lead to un-necessary support calls and bad user experience of the IPTV service.

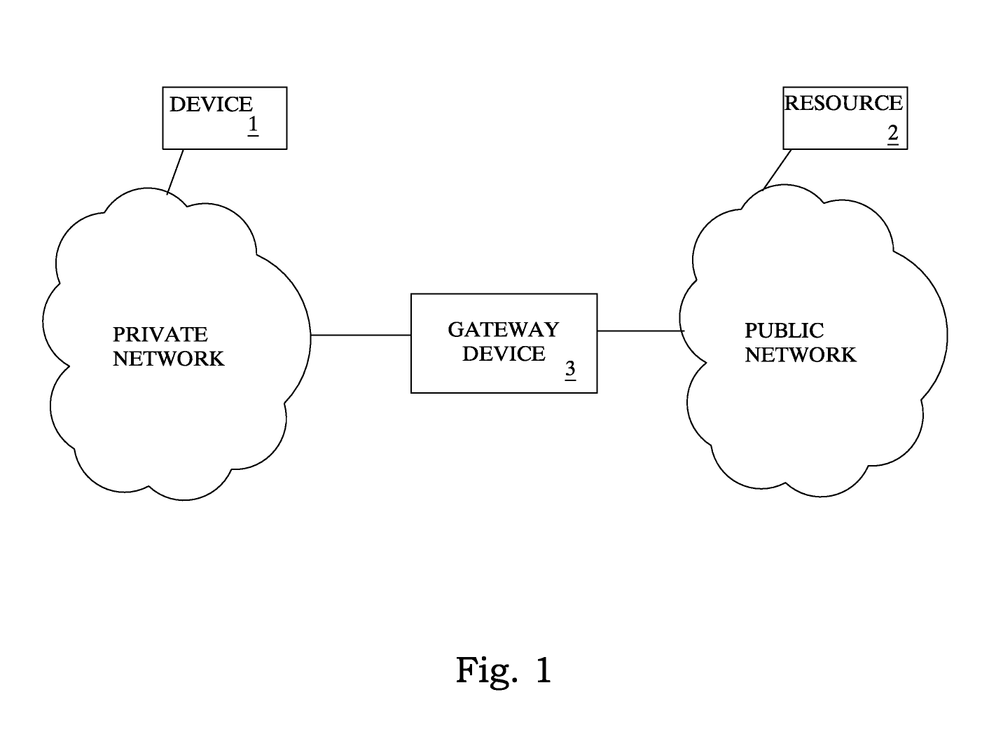

With reference to the schematic system in FIG. 1, in its most basic form, the present invention enables relaying requests for specific information between a device 1 associated with a private network and a resource provider 2 associated with a public network. This is enabled by means of a “man in the middle” solution in a gateway device 3 or similar device connecting the two networks.

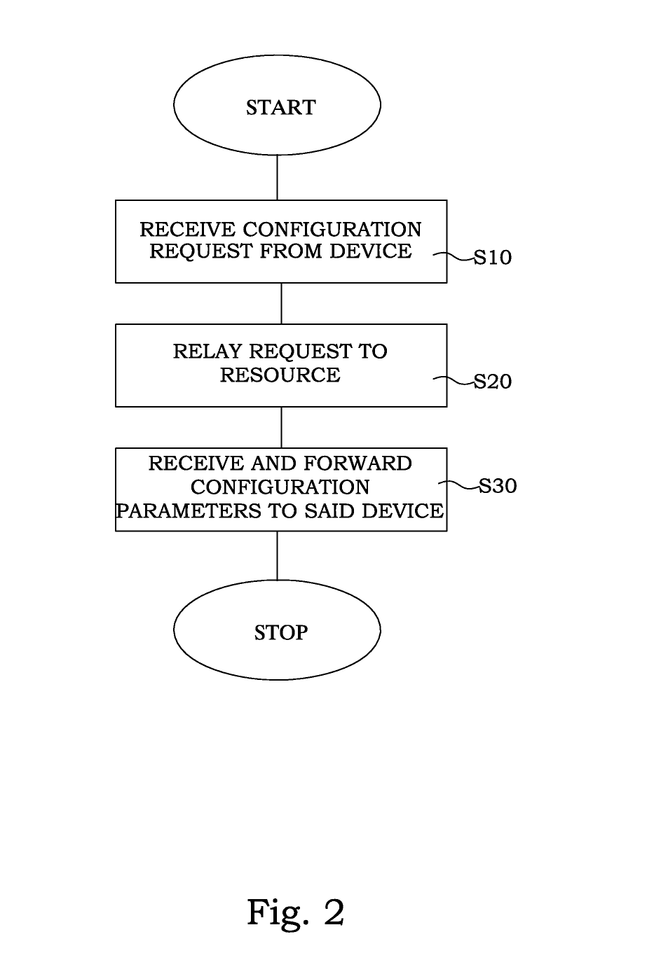

A basic embodiment of a method according to the invention will be described with reference to the system in FIG. 1, and the flow chart in FIG. 2. A user initiates a procedure for a device 1 e.g. a set top box or similar device, located in a private network, the procedure can be a configuration process for a communication session with a resource e.g. an IPTV provider or other service provider 2 that is located on another and public network. The two networks are typically connected or in communication with each other via an intermediate device, such as a gateway unit 3. In order to perform the procedure successfully, the device 1 needs configuration parameters from the resource 2. Consequently, a request for configuration parameters are sent to and received S10 at the gateway unit 3. The gateway unit is adapted to relay S20 the configuration request to the resource 2, and to receive and forward S30 configuration parameters back to the device 1. Thereby, providing the necessary information for a simplified configuration process.

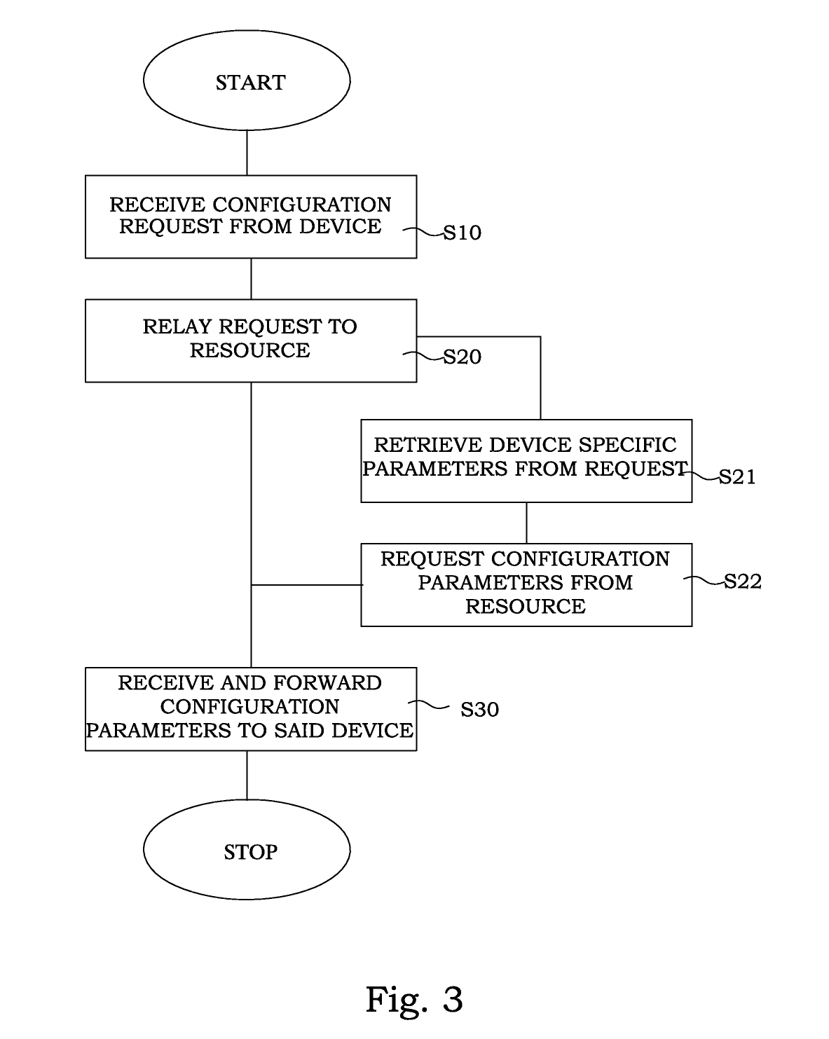

As mentioned previously, gateway devices and particularly residential gateway devices in IPTV networks are typically adapted to utilize Network Address Translation (NAT). NAT is a translation mechanism, which provides an interface between the set of IP addresses of the private network and the separate set of IP addresses of the public network. However, the use of NAT in a conventional manner prevents a request for device specific configuration parameters to be sent directly from the device, via the gateway and further on to the resource. Thus, the implementation of a method according to a further embodiment of the present invention will be described with reference to FIG. 3.

With reference to FIG. 3, the step of relaying S20 the configuration request in the gateway device is adapted to include a set of additional steps. In a first step S21 a set of device-specific parameters are retrieved from the configuration request. This is performed in order to enable the resource to identify the specific configuration parameters that are needed for the particular device. In a second step S22 the configuration parameters are requested from the resource based on the actual configuration request and the identified device specific parameters. Finally, the configuration parameters are received and forwarded S30 back to the device and the configuration can be concluded.

According to a further embodiment (not shown) upon receiving a configuration request in the gateway device, a search is performed. In this search, a storage device or memory is searched for previously received configuration parameters for the device. If there are locally stored configuration parameters for the device, those are communicated back to the device, thus rendering any step of retrieving a new set of configuration parameters from the resource un-necessary. However, since parameters may change and become obsolete, the method according to the present invention can be made conditional. In other words, if there is an available already stored set of parameters, but they set is older than a predetermined time interval, the process of requesting parameters from the resource is implemented. In this manner, the configuration process can be speeded up in cases of frequent configuration requests from the same device, while at the same time ensuring that the configuration parameters used are up to date.

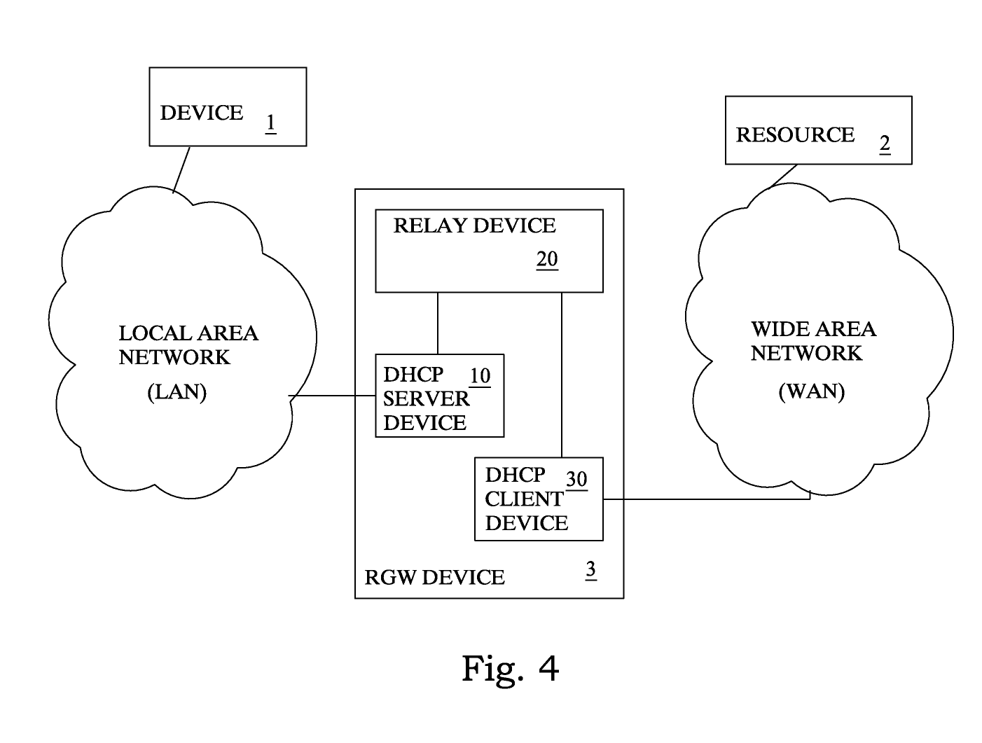

With reference to FIG. 4, a basic embodiment of an arrangement in a gateway device according to the present invention will be described.

The gateway device 3, arranged for use in an IP system, connects or enables communication between a user device 1 associated with a first network e.g. private network, and a resource or service provider 2 associated with a second network e.g. public network. Accordingly, the gateway device 3 comprises a unit 10 for receiving requests for configuration parameters from the user device 1. Further, a relaying unit 20 is adapted to relay the request from the device 1 to the resource 2. The relaying unit 20 is adapted to process the request from the receiving unit 10 and provide an adapted request at a retrieving and forwarding unit 30 that is arranged to retrieve configuration parameters from the resource 3 and forward them back to the device 1.

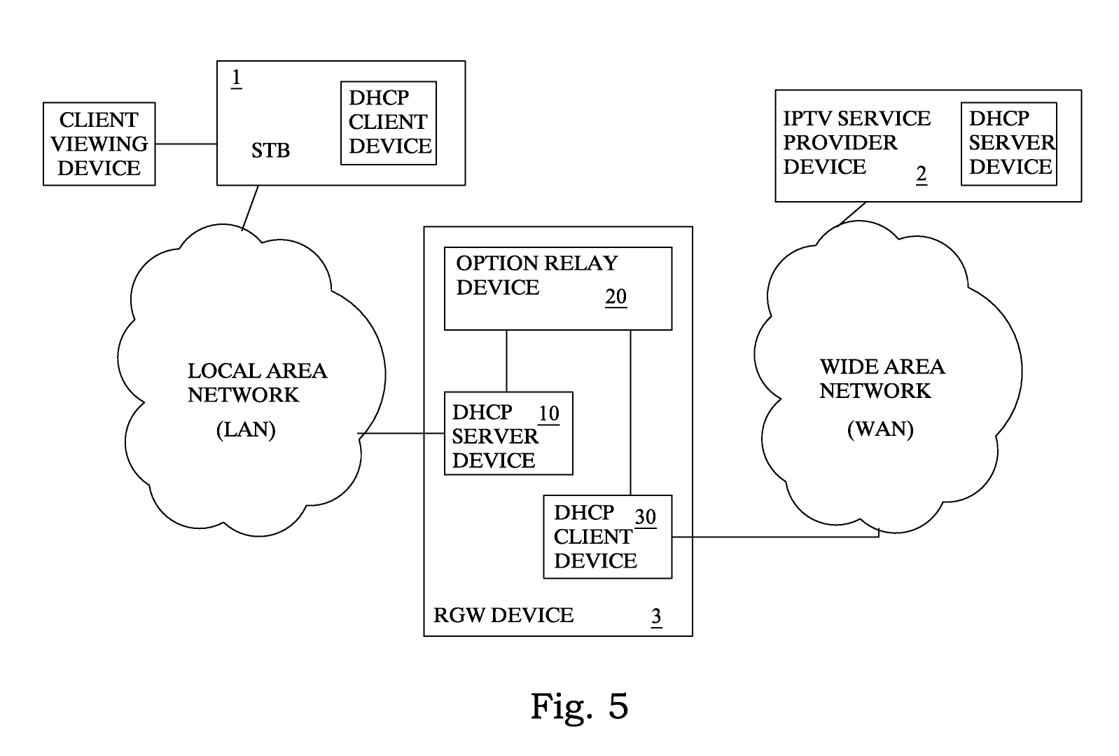

With reference to FIG. 5, a specific embodiment of a gateway device 3 will be described. Accordingly, a DHCP option relay 20 is implemented in or associated with a residential gateway device (RGW) 3. The option relay 20 serves to manage and translate specific information requests from a client device 1 of a private network e.g. LAN received at a server device 10 in the RGW, and adapting and forwarding those requests via a client device 30 in the RGW to a server device in or associated with a public network e.g. WAN. In the illustration of the embodiment, a LAN illustrates the private network, and the public network is illustrated by a WAN, but it is evident that the same solution can be applied to any combination of public and private networks where an exchange of specific information is necessary.

By introducing DHCP option relaying in the RGW 3, the need for end user configuration can be avoided. The DHCP option relay device 20 will interact with the DHCP server 10 on the LAN side and the DHCP client 30 on the WAN side. The DHCP option relay 20 retrieves the necessary information that identifies the STB from the STBs DHCP request and instructs the DHCP client 30 to retrieve the needed configuration information from the DHCP server on the IPTV network. The received information will be forwarded back to the STB via the DHCP option relay 20. DHCP inform messages can preferably be used for these requests.

By using the DHCP option relaying in the RGW the installation time and success rate for the installation of an IPTV STB can be improved.

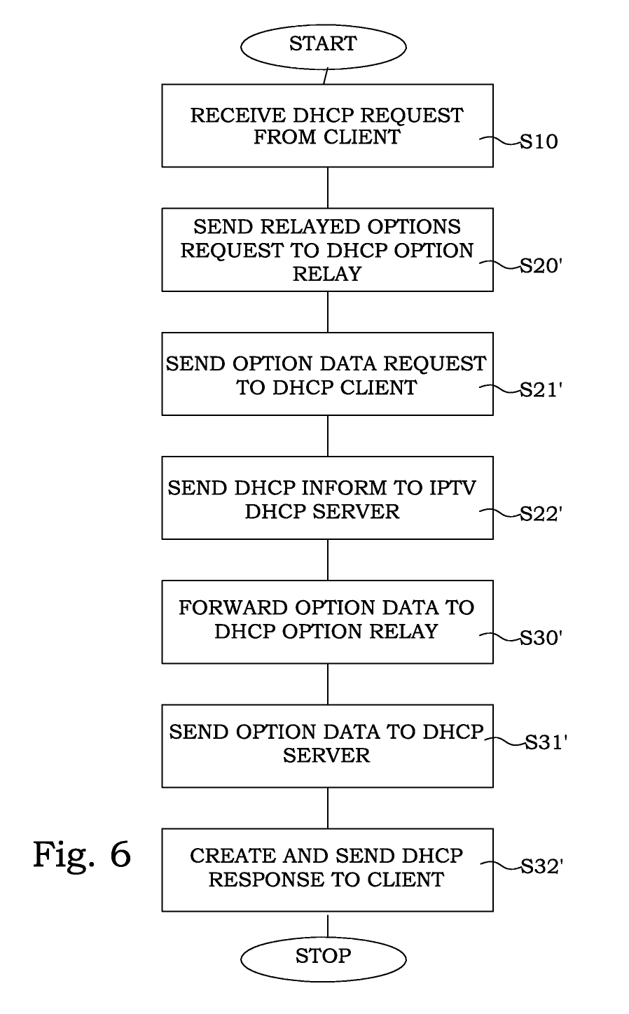

A particular embodiment of a method according to the present invention will be described with reference to FIG. 5 and FIG. 6.

Consider the situation where a client is in the process of activating and configuring his set top box 1 in a local area network (LAN). The local network is in communication with a wide area network (WAN) via a residential gateway RGW 3. The gateway RGW comprises a DHCP server device 10 for the LAN and a DHCP client device 30 for the WAN. In addition, the gateway RGW comprises or is associated with a DHCP option relay device 20, which is in communication with or bridges both the DHCP server 10 and the DHCP client 20.

On initiation by the user, the STB client device transmits a DHCP request S10 to the DHCP server in the gateway RGW. In response thereto the DHCP server 10 sends a request S20′ for relayed options to the DHCP option relay 20. In turn, the option relay 20 sends an option data request S21′ to the DHCP client 30. Subsequently, the DHCP client 30 sends S22′ a DHCP inform message to the resource e.g. DHCP server in the WAN or IPTV service network. An answer to the DHCP inform message is received at the DHCP client 30 and forwarded S30′ to the DHCP option relay 20. Subsequently, the DHCP option relay 20 sends S31′ the option data to the DHCP server 10, which in turn creates a full DHCP response and sends S32′ it to the STB client to complete the set up or configuration.

The arrangements according to the present invention can be further provided with means for storing previously retrieved sets of configuration parameters for each device associated with the private network. At least each device that has previously performed a boot or configuration. Upon receiving a request for configuration parameters, the relay is typically adapted to search a storage device or memory cache for previously retrieved sets of configuration parameters. If there are such sets available, the relay is adapted to enable the parameters to be sent directly back to the requesting device, without any need for retrieving them from the resource. However, since parameters can change and become obsolete, it is preferable to make this step conditional. Thus, if there are previously retrieved sets for parameters, a further check has to be performed to determine if the sets are still valid. In other words, preferably setting a condition that only previously received sets of configuration parameters that were received within a predetermined time period can be used. If the sets are older than the set limit, then the basic embodiment of the method is continued with relaying of the request to the resource and retrieving and forwarding the parameters back to the device for configuration.

The functionalities of the arrangements according to the present invention can be implemented using hardware or software or a mixture of both.

Advantages of the present invention comprise

Improved configuration accuracy
Reduced installation and configuration time
User neutral configuration

It will be understood by those skilled in the art that various modifications and changes may be made to the present invention without departure from the scope thereof, which is defined by the appended claims.

1-12. (canceled)

13. A method in a Network Address Translation (NAT) configured intermediate gateway device for configuring a user device in an IP system, said user device being associated with a first network for utilization of a resource associated with a second network, wherein said first and second networks communicate via said NAT configured intermediate gateway device, wherein the method comprises:
receiving a request for a set of configuration parameters associated with said resource from said user device;
relaying said request to said resource; and
retrieving and forwarding said requested set of configuration parameters from said resource to said user device for configuration of said user device.

14. The method according to claim 13, wherein said relaying comprises:
retrieving device specific parameters based on said request; and
requesting said set of configuration parameters from said resource based on said request and said retrieved device specific parameters.

15. The method according to claim 13, wherein said first network is a private network and said second network is a public network.

16. The method according to claim 15, wherein said private network is a local area network (LAN), said public network is a wideband area network (WAN), and said NAT configured intermediate gateway device is a residential gateway (RGW).

17. The method according to claim 16, wherein said user device is a set-top-box and said resource is an IPTV provider.

18. The method according to claim 17, wherein said request comprises a Dynamic Host Configuration Protocol (DHCP) request, and wherein said relaying said request to said resource comprises sending a DHCP Inform message to said IPTV provider.

19. The method according to claim 13, further comprising searching a storage device in said NAT configured intermediate gateway device for one or more sets of configuration parameters that have been previously received for said user device.

20. The method according to claim 19, wherein relaying said request to said resource comprises relaying said request if said storage device does not contain at least one set of configuration parameters that have been previously received for said user device.

21. The method according to claim 19, wherein relaying said request to said resource comprises relaying said request even if said storage device does contain at least one set of configuration parameters that have been previously received for said user device.

22. The method according to claim 21, wherein relaying said request to said resource comprises relaying said request if said at least one set of configuration parameters contained in said storage device was received outside a predetermined time interval.

23. The method according to claim 13, further comprising translating between addresses in the first network and addresses in the second network.

24. A Network Address Translation (NAT) configured intermediate gateway device for configuring a user device in an IP system, said user device being associated with a first network for utilization of a resource associated with a second network, wherein said first and second networks are connected via said NAT configured intermediate gateway device, wherein the NAT configured intermediate gateway device comprises:
a receiving unit configured to receive a request for a set of configuration parameters associated with said resource from said user device;
a relaying unit configured to relay said request to said resource; and
a retrieving and forwarding unit configured to retrieve and forward said requested set of configuring parameters from said resource to said user device for configuration of said user device.

25. The NAT configured gateway device according to claim 24, wherein the relaying unit is configured to relay said request to said resource by:
retrieving device specific parameters comprised in said request; and
requesting said set of configuration parameters from said resource based on said request and said retrieved device specific parameters.

26. The NAT configured gateway device according to claim 24, wherein said first network is a private network and said second network is a public network.

27. The NAT configured gateway device according to claim 26, wherein said private network is a local area network (LAN), said public network is a wideband area network (WAN), and said NAT configured intermediate gateway device is a residential gateway (RGW).

28. The NAT configured gateway device according to claim 27, wherein said user device is a set-top-box and said resource is an IPTV provider.

29. The NAT configured gateway device according to claim 28, wherein said request comprises a Dynamic Host Configuration Protocol (DHCP) request, and wherein said relaying said request to said resource comprises sending a DHCP Inform message to said IPTV provider.

30. The NAT configured gateway device according to claim 24, further comprising a storage device, and wherein the relaying unit is configured to relay said request if said storage device does not contain at least one set of configuration parameters that have been previously received for said user device.

31. The NAT configured gateway device according to claim 24, configured to translate between addresses in the first network and addresses in the second network.

32. The NAT configured gateway device according to claim 24, wherein the receiving unit comprises a DHCP server device, the relaying unit comprises an option relay device, and the retrieving and forwarding unit comprises a DHCP client device.
